(19) United States
(12) Patent Application Publication
(10) Pub. No.: US 2025/0369278 A1
(43) Pub. Date: Dec. 4, 2025

(54) Multi Function Dynamic Window

(71) Applicant: Glassai Tech Corp., Minnetonka, MN (US)

(72) Inventors: Hari ATKURI, Plymouth, MN (US); Vasyl SERGAN, Carmichael, CA (US); Mohan ATKURI, Plymouth, MN (US); Sivakumar PABOLU, Prosper, TX (US)

(73) Assignee: Glassai Tech Corp., Minnetonka, MN (US)

(21) Appl. No.: 18/863,106

(22) PCT Filed: Mar. 7, 2023
(86) PCT No.: PCT/IB2023/052128

§ 371 Date: Nov. 5, 2024

Related U.S. Application Data
(63) Continuation-in-part of application No. 17/688,481, filed on Mar. 7, 2022.
(60) Provisional application No. 63/443,353, filed on Feb. 3, 2023.
(60) Provisional application No. 63/443,150, filed on Feb. 3, 2023.

(51) Int. Cl. E06B 3/663; E06B 3/67

(52) U.S. Cl. CPC E06B 3/66304; E06B 3/66333; E06B 3/6722

(57) ABSTRACT

A dynamic window system is generally configured to provide controlled privacy, light intensity, heat transfer, or automation of such optical and aesthetic features. Optical panes may include a treated surface configured to scatter light for privacy generating a default opaque state. One or more fluids may be controllably dispensed into a cavity. The type of fluid cooperates with the treated surface to change the transmissivity of light through the window. Initial features of the fluid state of the window may be translucent, transparent, opaque, darker, reflective or a combination of them. Introducing one or more different fluids may change the initial features to a different set of features including translucent, transparent, opaque, darker, reflective state or a combination of them. Often the dynamic window comprises a single fluid and air cavity. In an advanced dynamic window, there could be at least two non-miscible fluids characterized by various physical and optical properties.

This application is a § 371 national phase of International application Ser. No. PCT/IB2023/052128, filed Mar. 7, 2023, titled Multi Function Dynamic Window, now expired; the '128 application claims priority of provisional of U.S. Provisional application Ser. No. 63/443,353, filed Feb. 3, 2023, titled Multi Function Dynamic Smart Window, now expired; the '128 application claims priority of provisional of U.S. Provisional application Ser. No. 63/443,150, filed Feb. 3, 2023, titled A Smart Dye Sensistized Solar Cell with Enhanced Light Control and Power Generation Capabilities, now expired; the '128 application is a continuation-in-part (C-I-P) of U.S. application Ser. No. 17/688,481, filed Mar. 7, 2022, titled Multi Function Dynamic Window. Each of these applications is incorporated by reference.

### BACKGROUND

The embodiments herein relate generally to optical panes used in windows or door and more particularly, to a multifunction dynamic glass for commercial or residential window and door applications.

Most of the glass used for windows and doors are static and do not provide dynamic functionality and related advanced features. Double-pane windows may sometimes include a gas in between the panes as insulation material to control heat transmission. Typical control of light transmission through glass is provided by layers of film or tint applied to outer surfaces of glass. Tinting film is generally static in the amount of light that is allowed to pass through the glass.

Also, current optical panes used in the windows or doors, are static. We cannot change the characteristics of the glass used in windows or doors. Characteristics such as color (dye), transparency, opaqueness, reflective or reactiveness. User need to change the complete glass, if the user wants to change any of the characteristics mentioned above.

Also, the energy consumed by buildings accounts for a significant portion of the total global energy consumption. One of the primary factors contributing to this energy consumption is the need for heating and cooling systems. Traditional HVAC systems rely on mechanical processes to regulate temperature, which can be inefficient and costly. To address this issue, researchers have been exploring novel methods of controlling the heat exchange in buildings.

Previous solutions or technologies that exist for this problem: Previous technologies are very limited but some of them are electro chromic and liquid-crystal based products for light control or privacy control respectively. Limitations of these previous solutions: The main challenges with the previous solutions are that their limitations in nature and the solutions available are not fully wetted or not suitable for residential or commercial applications.

There remains a significant need for smart or dynamic glass, which can have dynamic characteristics and further can be adjusted as per the needs of the user. The invention provides solution to the problem or need addressed in the prior arts. The ability to provide comfort, privacy or light control while providing an option to generate electricity at the same time.

### SUMMARY

The present invention relates generally to optical panes used in windows or doors and more particularly, to multifunction dynamic windows and doors used for commercial or residential applications.

The present invention further relates to an intelligent heat control system for buildings through the use of kinetic optical pane. More specifically, the invention relates to a system that monitors the building orientation with respect to environmental elements such as sun, geographical location of the dynamic pane location and its elevation to provide intelligent heat control by selecting the right fluid management system.

The present invention could also have an intelligent heat control system for buildings that uses fluid management in the optical panes to regulate heat exchange. The system includes sensors that monitor the building orientation with respect to environmental elements such as the sun and the geographical location of the dynamic pane location and its elevation and similar information. Based on this information, the system selects the appropriate fluid management to maintain optimal energy efficiency and comfort and glare control and view control.

The present invention describes a dynamic window including a first pane; a second pane, wherein the first pane and the second pane are arranged to define a cavity between the first pane and the second pane; a third pane, wherein the second pane and third pane are arranged to define a cavity between the second pane and third pane.

A treated surface on at least one of the first pane or the second pane or the third pane; a fluid container placed remotely or immediately coupled to one of the cavities of the panes for holding a material such as a fluid or a gas or a gel, wherein the material can be configured to be selected from a variety of air or fluids or gels characterized by various optical and physical properties; one or more ports positioned between the material container and one or more of the cavities; and a controller coupled to the material container, wherein the controller is configured to controllably manage one or more materials into one or more cavities through the port or ports to control a state of transmissivity, absorptivity, reflectivity, opacity, or other optical properties of light and power generation through the panes.

In another aspect of the subject technology, a multi-function dynamic window is provided. The window includes a frame. A first pane is housed in the frame. A second pane is housed in the frame. The first pane and the second pane are arranged to define a cavity. A treated surface is present on one of the first pane or the second pane or both of the panes. A fluid tank or container is coupled to the frame, for holding a fluid. A port is positioned between the fluid container and the cavity. A controller is coupled to the fluid container. The controller is configured to controllably dispense the fluid into the cavity through the port to control a state of transmissivity of light through the first pane and through the second pane.

In another aspect of the subject technology, a dynamic window system is provided. The system includes a double-paned window, including an air-gap between panes. An abraded surface is on the double-paned window. The abraded surface is configured to scatter light passing through the air-gap and generate a default opaque state of the window. A fluid chamber or container is coupled to the double-paned window and has access to the air-gap. A controller is coupled to the fluid container.

In another embodiment, there is no frame at all. The glass panes are arranged without the frame.

The controller is configured to dispense one or more fluids into the air-gap to change the double-paned window from the opaque state to a transparent or translucent state.

In one aspect of the subject invention, one or more black pigments that absorbs Infra-red (IR) and or reflects IR radiation. The use of such black pigments provides the user, an ability to tailor the IR reflectivity from 0 to 100% based on cold to hot geographical locations.

Further, in one of the embodiments, smart dynamic glass is used as dye sensitized Solar Cell or smart Façade that generates on demand power from sun or ambient light, which not only permits on demand light control applications but also on demand power generation similar as in a photovoltaic cell using the smart dye sensitized solar cell. This is achieved by introducing different optical media for light control and power generation.

A smart dye sensitized solar cell includes one or more base panes and a conductive pane made of conductive layer and a layer of TiO₂. The conductive layer of TiO₂ is sandwiched on one of the two transparent base panes containing a transparent metal oxide layer.

There can be a spacer, which is inserted between the two panes and the conductive TiO₂ layer.

In another embodiment, A Smart pane Façade with Enhanced Dynamic Light Control Capabilities by utilizing advanced geometry, adapted IG Design Fabrication, and the Introduction of Various Optical Media for Customized Applications and Aesthetic.

In another embodiment, there can be two or more panes in the window like three pane arrangement, where there are one or more cavities. These cavities are configured to be filed with air or fluid or optic material.

The optic material in the cavities between one or more panes is also defined as Kinetic material, which can be a fluid or a gel including gas which is in the range of submicron to couple of milli-meter (mm) thickness.

A system for operating a dynamic window includes one or more panes housed in a frame, wherein the one or more panes are surface treated, having a cavity; a reservoir connected to optical panes; a pump connected to reservoir for pushing the fluids to the cavity of optical pane; a power source connected to the electronic device; wherein the electronic device connected by the power source to control the transparency, opacity and/or color of the insulated glass.

The electronic device comprises the computer readable instructions to change the characteristics of the smart window.

The reservoir connected to the optical panes configured to store the various fluids, wherein the various fluids produce various characteristics in the optical panes.

A power source configured to be a lithium ion battery or AC or DC power source.

The pump is configured to supply fluids from the reservoir to the cavity of the optical panes.

There are various advantages of the inventions over existing solutions: The current invention are multi-faceted in nature and provides more than a standard or only-feature per technology such as light control only, privacy feature only or power generation only and combinations of. It is so far rare to have more than one of these features in a single product and have the flexibility to choose the feature on-demand.

### DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 is a front view of a dynamic window system in an opaque state according to an embodiment.

FIG. 2 is a cross-sectional side view of the dynamic window system of FIG. 1 with an empty fluid container according to an embodiment.

FIG. 3 is a front view of the dynamic window system of FIG. 1 including a section in a transparent state according to an embodiment.

FIG. 4 is a front view of the dynamic window system of FIG. 1 in a fully transparent state according to an embodiment.

FIG. 5 is a cross-sectional side view of the dynamic window system of FIG. 1 with a clear fluid container partially filled according to an embodiment.

FIG. 6 is a front view of the dynamic window system of FIG. 3 including the section in a transparent state, tinted according to an embodiment.

FIG. 7 is a front view of the dynamic window system of FIG. 4 in a fully transparent state, with a tinting element according to an embodiment

FIG. 8 is a cross-sectional side view of the dynamic window system of FIG. 1 with a colored (dye) fluid container completely filling an internal cavity of the window according to an embodiment.

FIG. 9 is a flowchart of a process for controlling a dynamic transparency of a window according to an embodiment.

FIG. 10 illustrates a block system diagram of the multi-function dynamic window, according to an embodiment of the present invention.

FIG. 11 illustrates a front view from room side and the window side view, as according to an embodiment of the present invention.

FIG. 12 illustrates the various views of the dynamic window from room side having various combinations of one or more optic materials, according to an embodiment of the present invention.

FIG. 13 illustrates another front view from the room side and window side view, as according to another embodiment of the present invention.

FIG. 14 illustrates various window views of the dynamic window with various combinations of one or more optic materials, as according to another embodiment of the present invention.

FIG. 15 illustrates the various arrangements/components of the optical pane layers, in according to the embodiment of the present invention.

FIG. 16 illustrates the various arrangements/components of the optical pane layers, in according to the embodiment of the present invention.

FIG. 17 illustrates the various room sideview of the window, in accordance to an embodiment of the present invention.

FIG. 18 illustrates the various arrangements/components of the optical pane layers, in according to the embodiment of the present invention.

FIG. 19 illustrates the various arrangements/components of the optical pane layers, in according to the embodiment of the present invention.

FIG. 20 illustrates the various arrangements/components of the optical pane layers, in with grounded EMF layer according to the embodiment of the present invention.

FIG. 21 illustrates 2 pane windows with different optics and electronic systems, in accordance with the embodiment of the present invention.

FIG. 22 illustrates different windows with different optical arrangement and electronic systems, in accordance with the embodiment of the present invention.

FIG. 23 illustrates different shaped windows with different optical arrangement and electronic systems, in accordance with the embodiment of the present invention.

FIG. 24 illustrates 2 pane arrangements with a conductive layer, in accordance with the embodiment of the present invention.

FIG. 25 illustrates single pane arrangement with a conductive layer, in accordance with the embodiment of the present invention.

### DESCRIPTION

The detailed description of some embodiments of the invention is made below with reference to the accompanying figures, wherein like numerals represent corresponding parts of the figures.

A dynamic window, includes a first pane, a second pane, wherein the first pane and the second pane are arranged to define a cavity between the first pane and the second pane, a third pane, wherein the second pane and third pane are arranged to define a cavity between the first pane and second pane.

A treated surface on one of at least the first pane or the second pane or third pane, a fluid container coupled to the optical panes, for holding a fluid, wherein the fluid can be configured to be selected to air or fluids or gels; one or more fluids to control the absorption and/or reflection of UV, visible and infra-red (IR) radiations; one or more ports positioned between the fluid container and one or more of the cavities; and a controller coupled to the fluid container, wherein the controller is configured to controllably manage one or more fluids into one or more cavities through the port or ports to control a state of transmissivity, absorptivity, reflectivity of light through the first pane and through the second pane.

The treated surface of dynamic heat control dynamic window configured to be a roughened surface or hydrophobic surface or hydrophilic surface or oleophobic surface.

The treated surface of dynamic heat control dynamic window is on an inner surface of either the first pane or the second pane or both panes, and the inward surface is facing toward the cavity.

The treated surface of dynamic heat control dynamic window is configured to provide a default opaque or clear or any optical state in an absence or presence of one or more fluids in the cavity.

The fluid used in the cavity of dynamic heat control dynamic window includes a clear fluid, and a presence of the clear fluid in the cavity generates a transparent condition through the first pane and through the second pane.

The fluid used in the cavity of the dynamic heat control dynamic window includes a colored (dye) fluid, and a presence of the colored fluid in the cavity changes the state of transmissivity from an opaque state to a translucent or to other states based on the fluid and selection of surface treatments.

A fluid container of dynamic heat control dynamic window comprises a first container and a first clear or opaque or colored fluid in the first container, a second container and a second different colored or clear or opaque fluid in the second container, different from first fluid, wherein a dispense of the clear fluid into the cavity transforms the state of transmissivity from a default opaque state to a transparent state, and a dispense of the colored fluid into the cavity changes the state of transmissivity from the transparent state to a translucent state.

A dynamic heat control dynamic window system, includes a double-paned window, including an air-gap between panes, an abraded surface on the double-paned window, wherein the abraded surface is configured to scatter light passing through the air-gap and generating a default opaque state of the window; a fluid container coupled to the double-paned window and having access to the air-gap; and a controller coupled to the fluid container, wherein the controller is configured to dispense and one or more fluids into the airgap to change the double-paned window from the opaque state to a transparent or translucent state.

The dynamic heat control window system, wherein a first fluid is a clear fluid and a second fluid is a colored fluid.

In response to the clear fluid being in the air-gap, the double-paned window changes from the opaque state to a transparent state, and in response to the colored fluid being in the air-gap simultaneously with the clear fluid, the double-paned window changes from the transparent state to the translucent state.

At least one of the panes in the dynamic heat control window is a double glazed unit or triple pane insulating unit is the kinetic glass or also called dynamic window.

The kinetic glass comprising a plurality of layers, wherein at least one fluid layer is capable of movement in response to an external force, wherein the movement of said layer is controlled by an actuator, and wherein said kinetic glass is capable of transitioning among at least a first optical state and a second optical state in response to a control signal such that, for example, top portion of the window can be completely dark and opaque from fluid 1 whereas the remaining bottom portion of the window can be transparent from fluid 2 to view the other side of the dynamic window. Fluids 1 and 2 are often non-miscible and have specific optical and physical properties.

The fluid may include at least one fluid such as clear or transparent or opaque or dark or translucent or absorbing or reflective or similar fluid, and a presence of at least one of such fluids create optical effects not limited to light control effects such as transparent, clear, reflective, absorbing, dark, opaque or translucent effects or similar effects. In the absence of one or more fluid in the cavity generates the completely desired optical state depending on the pane color and selection and often creates a clear view of the environment on the other side.

A system for operating a dynamic heat control window comprises one or more panes housed in a frame, wherein the one or more panes are surface treated, having a cavity; a reservoir connected to optical panes; a pump connected to reservoir for pushing the fluids to the cavity of optical pane; a power source connected to the electronic device; wherein the electronic device connected by the power source to control the transparency, opacity and/or color of the insulated glass.

The electronic device connected with the dynamic heat control window includes the memory to store the computer readable instructions to change the characteristics of the dynamic window.

The reservoir connected to the optical panes configured to store the various fluids, wherein the various fluids produce various characteristics in the optical panes.

A power source includes at least one of an energy storage device or a connection to line power. The power source includes an energy storage device in the form of a battery operable to be mounted in the battery compartment. For example, the battery may be provided in the form of a replaceable coin cell battery. As another example, the energy storage device may be provided in the form of a rechargeable battery or a supercapacitor, and the power source may include an energy harvester operable to charge the energy storage device. Such an energy harvester may, for example, take the form of an inductive power receiver operable to receive power from an inductive power generator, or the form of a photocell operable to harvest energy when exposed to electromagnetic radiation (e.g., sunlight and/or artificial light). As should be appreciated, the power source may further comprise a circuitry configured to place the power provided by the power source in a form usable by the controller, pump and/or other electronic components of the dynamic heat control window.

The pump is configured to supply air or fluids or gels from the specific reservoirs or from other panes to the specific cavity of the specific optical panes.

The fluid is characterized by various optical and physical properties selected from at least one polar or non-polar fluids or more fluids that are generally non miscible.

The electronic device connected to dynamic heat control window, includes a memory, electronics, IoT, fluid managements, sensors and a processing unit, where the memory stores the computer readable instructions which are processed by the processing unit.

The fluids in dynamic heat control window are configured to be fluid communication within the optical panes of one or more windows. The fluid can be transferred from one optical pane window to another optical pane window.

The one or more non miscible fluids are stored in one container or more than one container or in a compartmentalized container or no container at all. In no container scenario, the fluids are transferred from one optical pane to another optical pane, which are connected.

The dynamic heat control window is configured to be used for dye sensitized solar cell or glass.

The dynamic heat control window can also be used in a medical room or similar facility, with no magnetic or electric inference by adding a grounded conductive coating on any of the surface layer.

A system for intelligent heat and light control in a building includes a control unit, one or more sensors for monitoring building orientation with respect to environmental elements such as the sun, wind, and geographical location of the dynamic pane location and its elevation; a fluid management system for regulating heat exchange based on the data from the sensors; and the fluid management system for circulating a fluid or gel through the building's façade based on the computer readable instructions selected by the control unit.

The system is capable of adapting to changing environmental conditions and optimizing energy efficiency or comfort, depending on the user's preferences.

A fluid-based smart dye-sensitized solar cell includes a) a photoelectrode layer coated with a dye-sensitized fluid electrolyte comprising at least one redox couple; b) a counter electrode layer configured to allow passage of electrons to the photoelectrode layer; and c) a transparent conductive substrate layer positioned between the photoelectrode layer and the counter electrode layer.

The dye-sensitized fluid electrolyte comprises a mixture of a sensitizer dye and a redox mediator.

The photoelectrode layer comprises a semiconductor material selected from the group consisting of titanium dioxide, zinc oxide, and tin oxide.

The counter electrode layer comprises a metal or conductive polymer selected from the group consisting of platinum, gold, palladium, and polyaniline.

In one embodiment of the present invention, the system comprises a control unit, sensors, electronics, IoT, fluid management s, and a fluid management system. The required information could be provided into the intelligent system manually or thru sensors integrated with the pane system installed into the building to monitor the building orientation with respect to environmental elements such as the sun, wind, humidity, UV radiation, IR radiation, VLT and geographical location of the dynamic pane location and its elevation. The sensor data is transmitted to the control unit, which analyzes the data and selects the appropriate fluid management.

The fluid management s determines which fluid and how much fluid for each fluid material to use to reflect, transmit or absorb heat. The same applies to management of light control functions such as light transmission, reflection, absorption or combination of all three, which is often the case. For example, in situations where the sun is shining on the building, the system may select increases the amount of a specific fluid used to reflect sunlight or IR radiation. In other situations, such as during winter months, the system may select a decreases the percent amount of sun-light reflecting fluid and increases the percentage of sunlight transmitting or absorbing fluid to absorb heat or transmit warmth.

The fluid management system includes a reservoir of fluid, or a gel, or a gas that is circulated through the multifunction pane or façade. The fluid can be selected based on its thermal properties, optical properties, such as its ability to absorb or reflect heat and other performance properties.

In operation, the system continuously monitors the building's orientation with respect to environmental elements and adjusts the fluid management accordingly. The system can be programmed to optimize energy efficiency or comfort, depending on the user's preferences where the fluids inside the smart pane are automatically adjusted to provide certain benefits to the occupant.

The present invention provides several advantages over traditional windows and many other advanced smart pane or glass systems in the market where the system also competes, to some extent, with traditional HVAC systems. The system can reduce energy consumption by regulating heat exchange more efficiently by the management of various fluid selections in the smart window or pane. Additionally, the system can be customized to optimize energy efficiency or comfort, depending on the user's preferences. The fluid management is adaptable to changing environmental conditions, which makes the system more efficient and effective at maintaining optimal thermal conditions in the building.

The present invention is an intelligent heat control system for buildings that uses fluid management to regulate heat exchange. The system provides several advantages over traditional HVAC systems, including increased energy efficiency, customizability, and adaptability to changing environmental conditions. The invention is scalable and can be incorporated into new or existing buildings, making it an ideal solution for sustainable building design.

The characteristics of the multifunction dynamic window are on demand light control including but not limited to the control of privacy, opacity, transparency, absorption, reflectivity and power generation. These features are achieved by following.

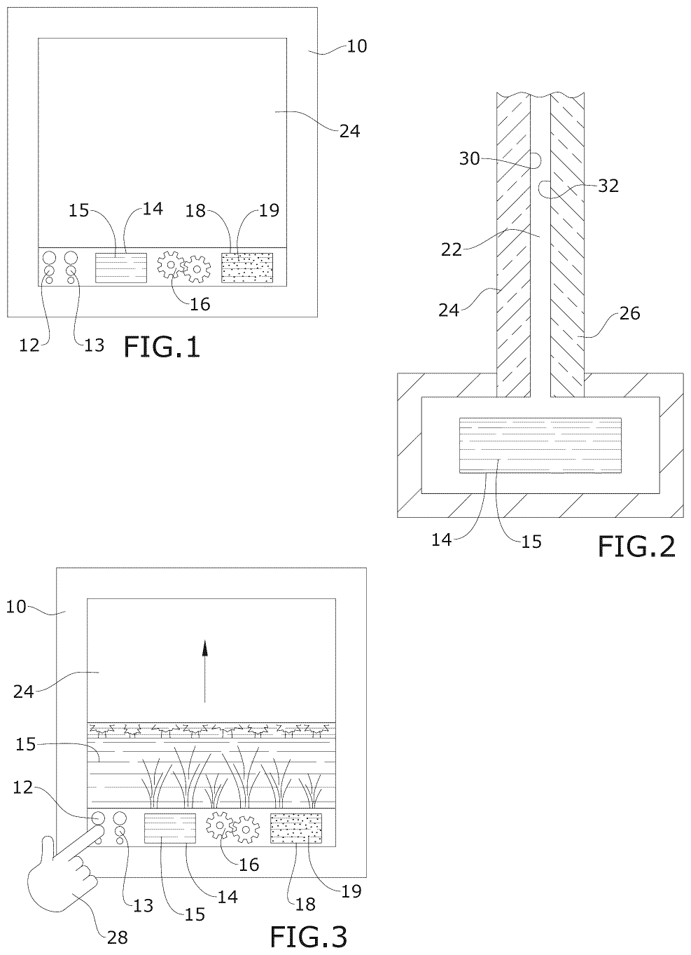

By way of example, and referring to FIGS. 1-8, a dynamic window system (sometimes referred to generally as the “system”) is shown according to an illustrative embodiment. The system is generally configured to provide controlled privacy, light intensity, a level of transparency or automation of such features. The system may be adapted for different scenarios. The applications for the scenarios include, for example, commercial, residential, multi-family living, aviation, marine, and auto industry without any immediate limitations. In simple terms, the product is adaptable anywhere a glass product is usable with minimal or no modifications to the fenestration and glazing.

In an illustrative embodiment, the dynamic window system 10 may be a double pane window that includes panes 24 and 26. The panes 24 and 26 may be glass, plastic, polyethylene terephthalate (PET), Polyethylene naphthalate (PEN), or other clear, light transmissive material. The panes 24 and 26 may be separated by a pre-set distance, defining an empty cavity or air-gap 22 there between. The panes 24 and 26 may be transparent. At least one surface of either or both panes 24 and 26 is treated to scatter light. For example, the inner surfaces 30; 32 of one or both pane substrates may be processed to produce a treated surface. One illustrative form of treatment may include for example, roughening or abrasion of a surface. Illustrative embodiments may roughen for example, one or both of inner surfaces 30 and 32. Surfaces 30 and 32 may be the surfaces of respective panes 24; 26 that face inward toward the cavity 22. In one embodiment, the treated surface(s) create a default opaque state in the system in the absence of fluid within the cavity 22. FIG. 1 represents an opaque state.

The system may include a fluid container coupled to the panes 24 and 26, with access to the cavity 22 through one or more ports. The panes 24 and 26 and the fluid container may be housed within a frame 10. The fluid container may hold one or more fluid types that are controllably released into the cavity 22 to change the state of transmissivity through the panes 24 and 26.

In an illustrative embodiment, the fluid container comprises a first fluid container 14 and a second fluid container 18. The fluid container 14 may store a clear fluid 15. The fluid container 18 may store a colored fluid 19 (for example, a colored fluid). Introduction of either fluid 15 or 19 changes the state of transmissivity through the panes 24 and 26.

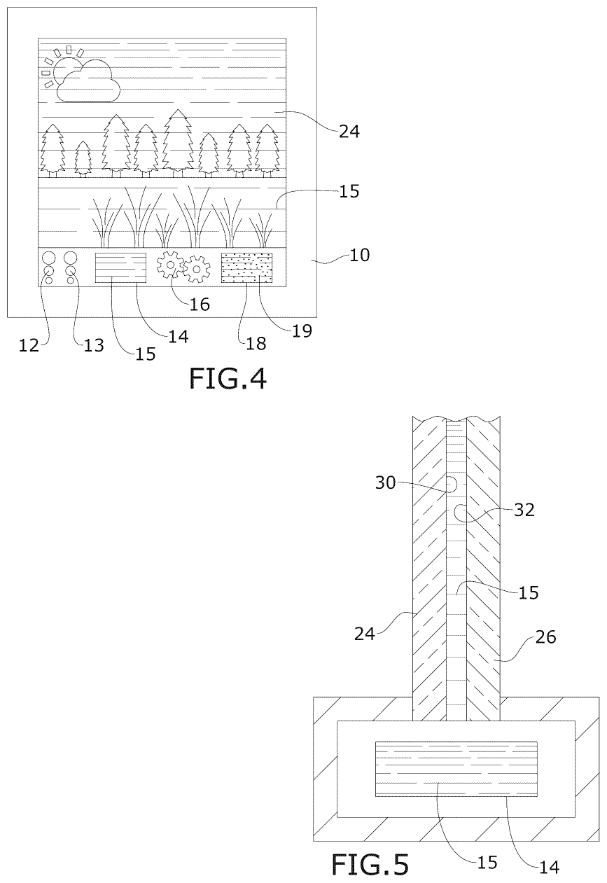

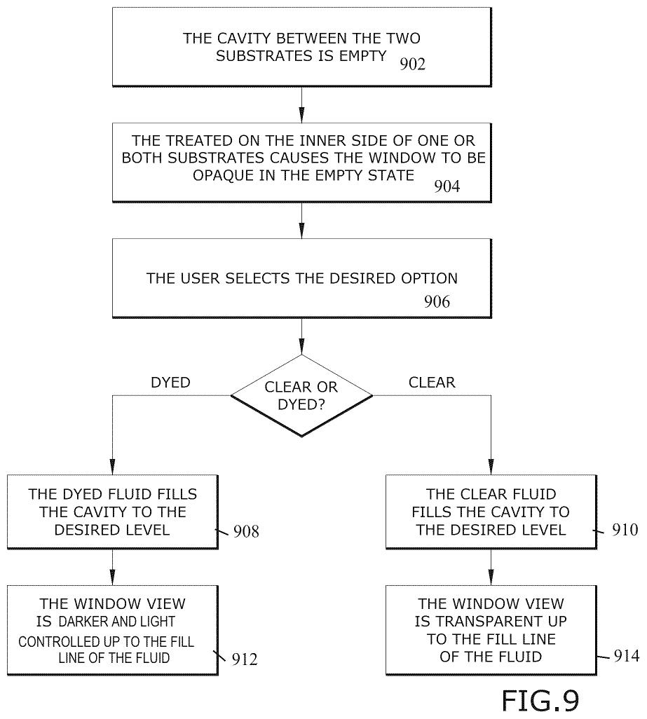

FIGS. 1-8 are described below with concurrent reference to FIG. 9 which discloses an illustrative operation process of the system according to some embodiments. Generally, the system may be operated starting from the default state where the cavity 22 between panes 24 and 26 is empty. In one illustrative example, supplying the clear fluid 15 into the cavity 22 causes changes to how light is scattered as the light passes through the panes 24 and 26. The clear fluid cooperates with the treated surface to minimize scattering since the fluid optically “fills” in the micro refractive surfaces. The system transforms from the opaque state to a transparent state. FIG. 3 represents a bottom section of the system becoming transparent where the level of fluid 15 has risen up into the cavity 22. FIGS. 4 and 5 shows the fluid 15 rising within the cavity 22 filling up the entire viewable area inside the frame 10 so that the panes 24 and 26 become transparent.

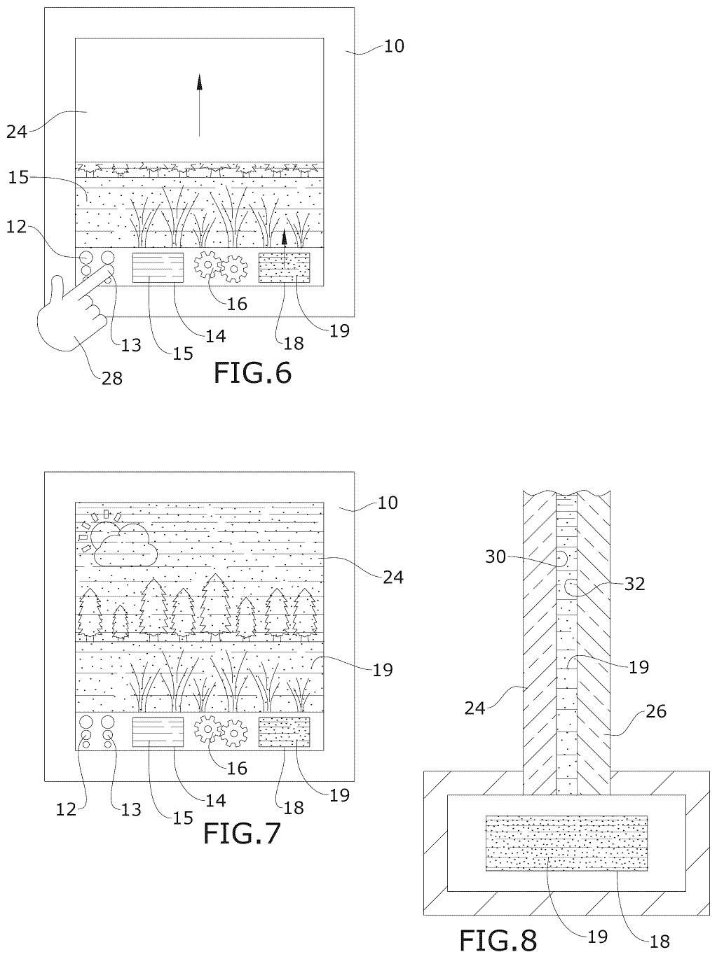

Supplying the colored fluid 19 may also change the state of transmissivity through the panes 24 and 26. In one illustrative embodiment, the colored fluid 19 may be supplied into the cavity 22 after the clear fluid 15 has been introduced to control the light intensity passing through the system. The colored fluid 19 may change the state of transmission from transparent to translucent allowing some light to pass through while keeping the background visible but at a less intense level. FIG. 6 shows a bottom section of the viewable area that has previously been filled with clear fluid 15 in a state that is receiving colored fluid 19 as well. The bottom section has become less than transparent but not opaque. The top section remains opaque since neither fluid type has made contact with the treated sections of the panes 24 and 26 at the upper levels of the system. FIGS. 7 and 8 show the colored fluid 19 rising up the cavity 22 to fill the entire viewable area of the system shading out some of the light passing through the panes 24 and 26.

Some embodiments include an operating system to controllably dispense the fluids into the cavity 22 to provide different heights of coverage within the cavity 22 at different levels of transparency or privacy. The user may for example, select from a fill selection panel which controls the different levels of fill and transparency.

In one illustrative example, the system includes a control panel 12 controlling the amount of clear fluid 15 that is dispensed into the cavity 22. A control panel 13 may control how high up the cavity 22 the colored fluid 19 is dispensed. Also, the amount of colored fluid 19 that is dispensed may control the level of translucence/light blocking desired by a user. Hardware 16, for example a pump or other dispensing device, may be operated according to the settings entered into control panels 12 and 13.

FIG. 9 illustrates the operational flow chart where various steps are performed. At Step 902: The cavity between the two substrates or panes is empty. It is the initial stage or phase.

At Step 904: the surface of the substrate is treated on the inner side of one or both the substrates or panes. This causes the window to be opaque in the empty or initial stage.

At Step 906: The user selects the desired optical option to choose between colored view of the other side of the dynamic window and clear views.

At Step 908: On selection of dyed substrate, the dyed fluid fills the above mentioned cavity to the desired level.

At Step 910: On selection of clear substrate, the clear fluid fills the cavity to the desired level.

At Step 912: The window view is darker ad light controlled is up to the fill line of the fluid.

At Step 914: The window view is transparent or clear up to the fill line of the fluid.

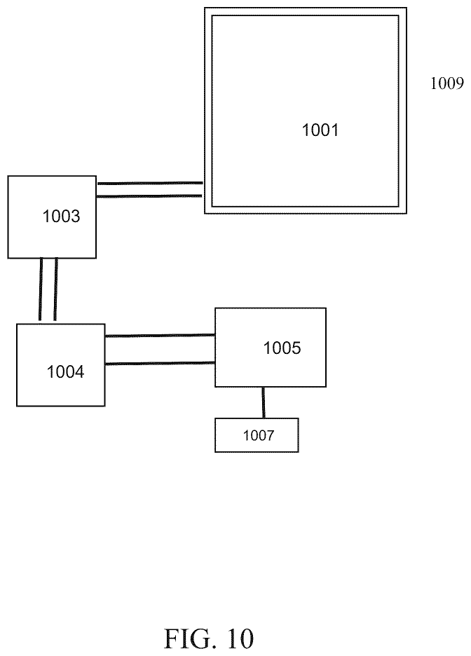

FIG. 10 illustrates a block system diagram of the multi-function dynamic window. One or more optical panes 1001 includes a cavity 1009, a reservoir 1003 to store the fluid, where the fluid can be selected from either polar or non-polar materials, a pump 1004 is used to pump the fluid from the reservoir to the cavity of the optical panes, a power source 1007 is connected to the pump, wherein the power sources can be selected from a lithium battery or an AC source or DC source. The electronic device 1005 connected to the power source, wherein the electronic device comprises a memory, sensors and a processing unit, wherein computer readable instructions in memory, processed by processing device to change the characteristics of the optical panes. The electronic device, where the memory comprises the computer readable instructions.

The Block/s Represent various optics materials management system that allows the materials to occupy a particular area of the dynamic window to produce a desired optical effect within the particular area of the window.

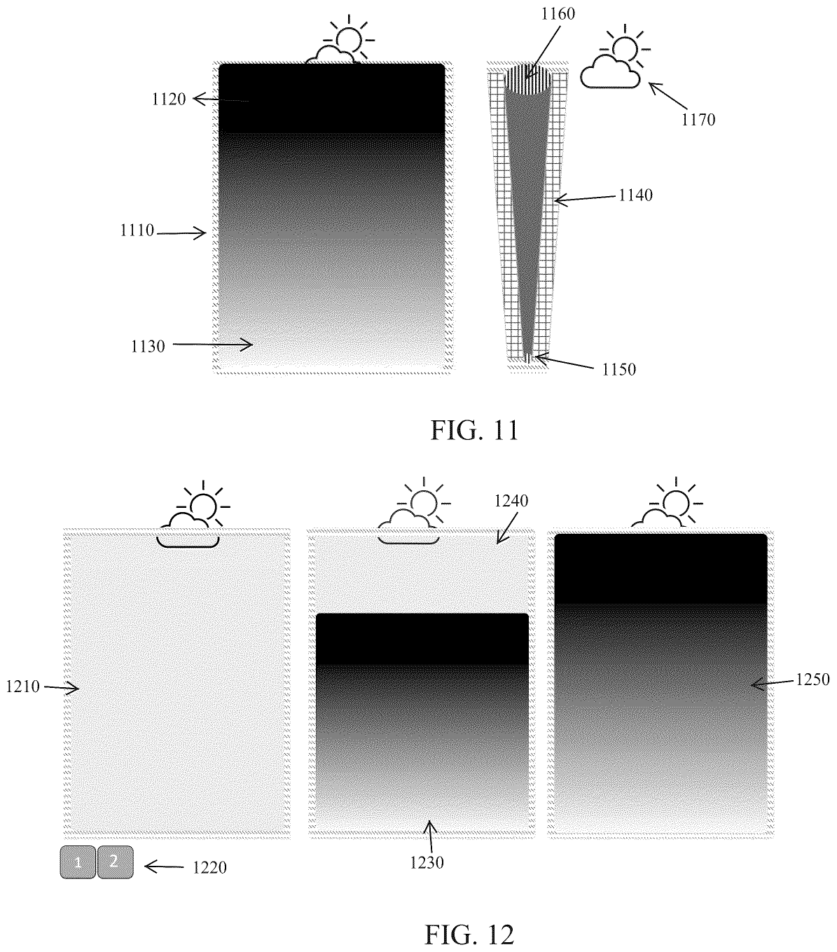

FIG. 11 illustrates the front side view from the room of the dynamic window side having various combinations of one or more optic fluids. The brightness from the outside to inside of the room depends upon the type and volume of optic material used. As illustrated clearly in the FIG. 11, 1110 is the sealant, which seals the optical panes to the frame, optic 1 or the first fluid 1130 in the lower portion is more transparent than the second fluid 1120 in the upper portion. The window side view illustrates the optical pane 1140, sun 1170 to provide light or heat and 1150 and 1160 are the spacers in the optical panes. The first and second fluid is put into the cavity of the panes. The first and second fluid is configured to be different and having different optical properties. The same can be observed in FIG. 12, with three window variations shown. 1 and 2 at the bottom are the electric connections or systems connected to the window. Based on the selection of the optic fluid using the electric systems 1220 produces different effects on the window, where 1210, when clear or transparent fluid is selected for the entire window or optical pane cavity. So, at 1210, complete window is transparent. At 1230, which represents the darker or dyed fluid having darker optical properties up to the fill level in the cavity, rest cavity is filled with transparent fluid to have transparent or clear effect as illustrated by 1240. At 1250, the entire cavity is filled with dyed fluid, So, the entire window is dark colored with no transparent liquid.

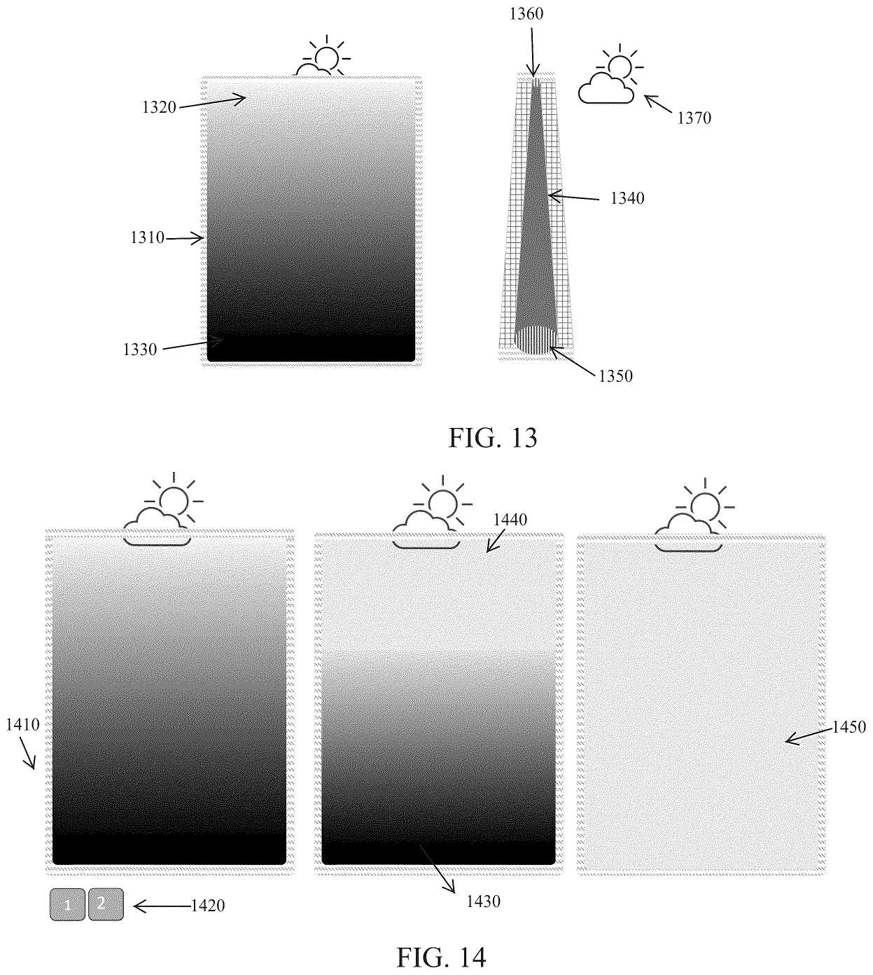

FIG. 13 illustrates the front side view from the room of the dynamic window side having various combinations of one or more optic fluids, wherein the optic fluid used in one of the embodiment as illustrated in FIG. 11 is different or same. The brightness from the outside to inside of the room depends upon the type and volume of optic material used. As illustrated clearly in the FIG. 11 and FIG. 13. As illustrated clearly in the FIG. 13, 1310 is the sealant, which seals the optical panes to the frame, optic 1 or the first fluid 1320 in the upper portion is more transparent than the second fluid 1330 in the lower portion. The window side view illustrates the optical pane 1340, sun 1370 to provide light or heat and 1350 and 1360 are the spacers in the optical panes. The first and second fluid is put into the cavity of the panes. The first and second fluid is configured to be different and having different optical properties. The same can be observed in FIG. 14, with three window variations shown. 1 and 2 at the bottom are the electric connections or systems 1420 connected to the window. Based on the selection of the optic fluid using the electric systems produces different effects on the window, where 1450, when clear or transparent fluid is selected for the entire window or optical pane cavity. So, at 1450, complete window is transparent. At 1430, which represents the darker or dyed fluid having darker optical properties up to the fill level in the cavity, rest cavity is filled with transparent fluid to have transparent or clear effect as illustrated by 14400. At 1410, the entire cavity is filled with dyed fluid, So, the entire window is dark colored with no transparent liquid in the cavity.

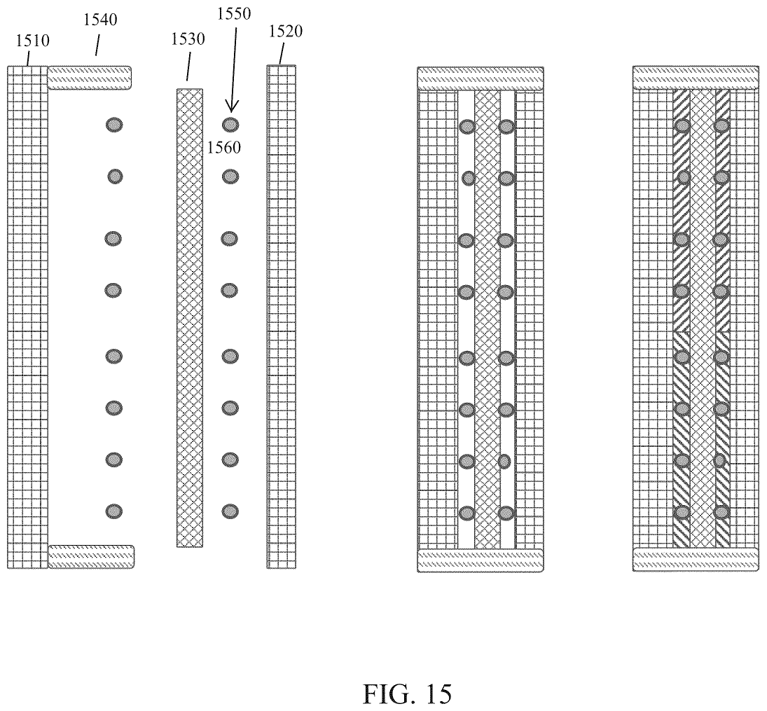

FIG. 15 illustrates the various arrangements/components of the optical panes (?) in a window, where 1510 and 1520 represents the optical panes, 1530 represents the conductive layer, 1540 represents the sealant to seals the opposite end of the optical panes and 1550 represents the spacer between the various layers or optical panes. The optical effects produced are based on the optical and physical properties of the fluid, which is filled in the cavity represented by 1560.

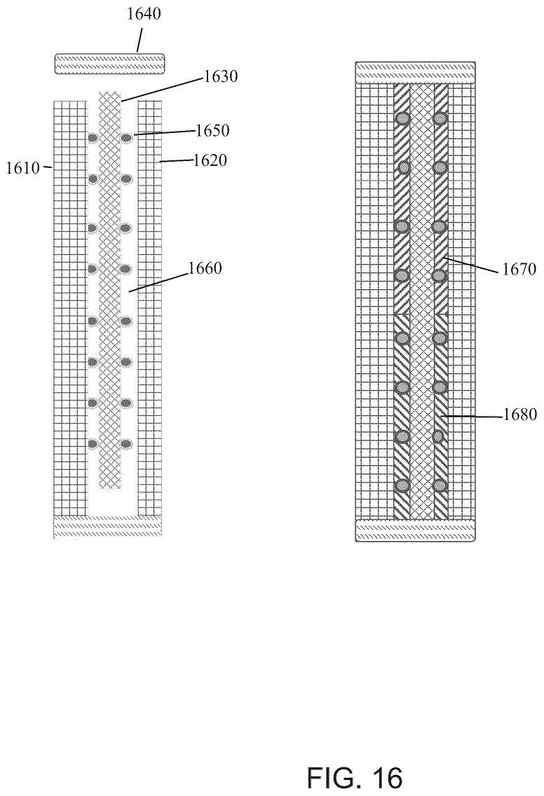

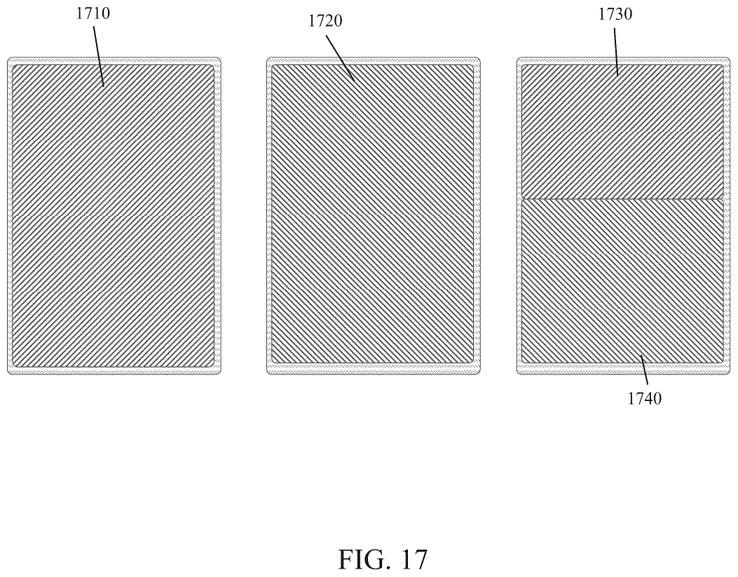

FIG. 16 illustrates the various arrangements/components of the glass layers in aw window, where 1610 and 1620 represents the optical panes, 1630 represents the conductive layer, 1640 represents the sealant sealing the opposite end of the optical panes and 1650 represents the spacer between the various layers or optical panes. The optical effects produced are based on the optical and physical properties of the fluid, which is filled in the cavity represented by 1660. As illustrated by 1670 and 1680, based on the fluid type, upper and lower section may have similar or different optical properties.

FIG. 17 illustrates the various room side views of the window, where 1710 and 1720 represents window with single fluid, the fluid used in the 1710 and 1720 may be same or different optical properties. Further window 1730 and 1740 are different fluids in a single window having different optical properties.

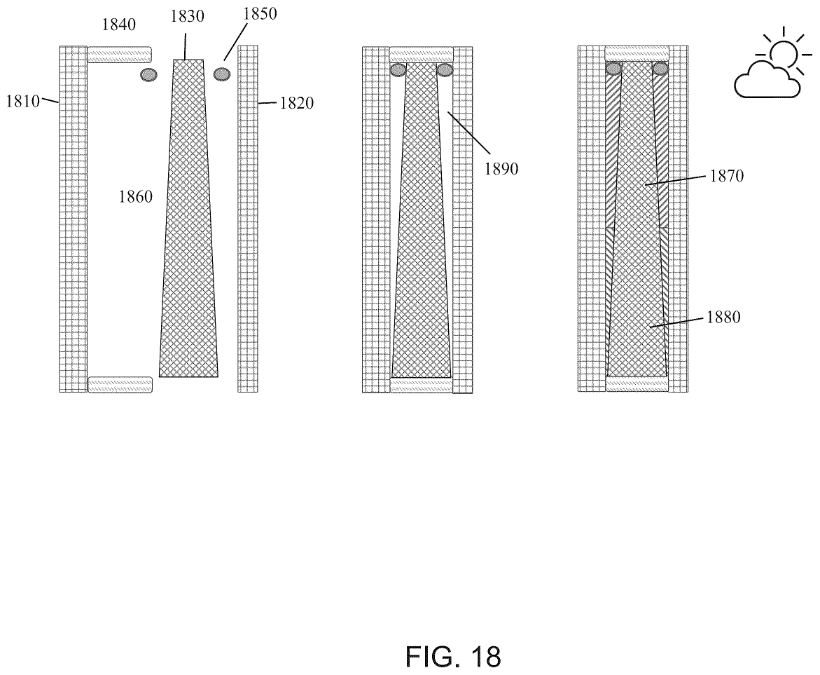

FIG. 18 illustrates the various arrangements/components of the glass layers in a window, where 1810 and 1820 represents the optical panes, 1830 represents the wedge shaped conductive layer, 1840 represents the sealant to seals the opposite end of the optical panes and 1850 represents the spacer between the various layers or optical panes. The effects produced are based on the fluid, which is filled in the cavity represented by 1860. The fluid having optical properties. As illustrated by 1870 and 1880, based on the fluid type, upper and lower section may have similar or different optical properties.

In another embodiment, it is also possible to leave the cavity empty or without fluid. To have clear or transparent effect as illustrated by 1890 in FIG. 18.

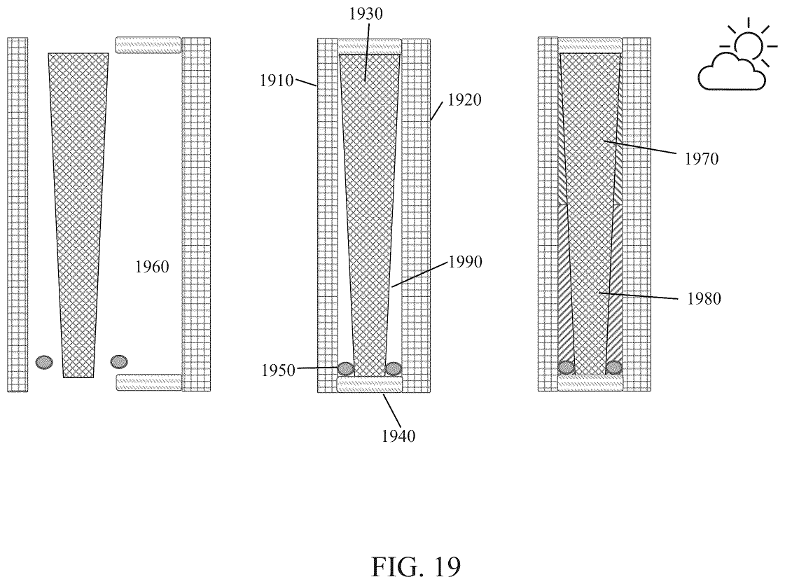

FIG. 19 illustrates the various arrangements/components of the glass (?) layers in aw window, where 1910 and 1920 represents the optical panes, 1930 represents the wedge shaped conductive layer, 1940 represents the sealant to seals the opposite end of the optical panes and 1950 represents the spacer between the various layers or optical panes. The effects produced are based on the fluid, which is filled in the cavity represented by 1960. The fluid having optical properties. As illustrated by 1970 and 1980, based on the fluid type, upper and lower section may have similar or different optical properties.

In another embodiment, it is also possible to leave the cavity empty or without fluid. To have clear or transparent effect as illustrated by 1990 in FIG. 19.

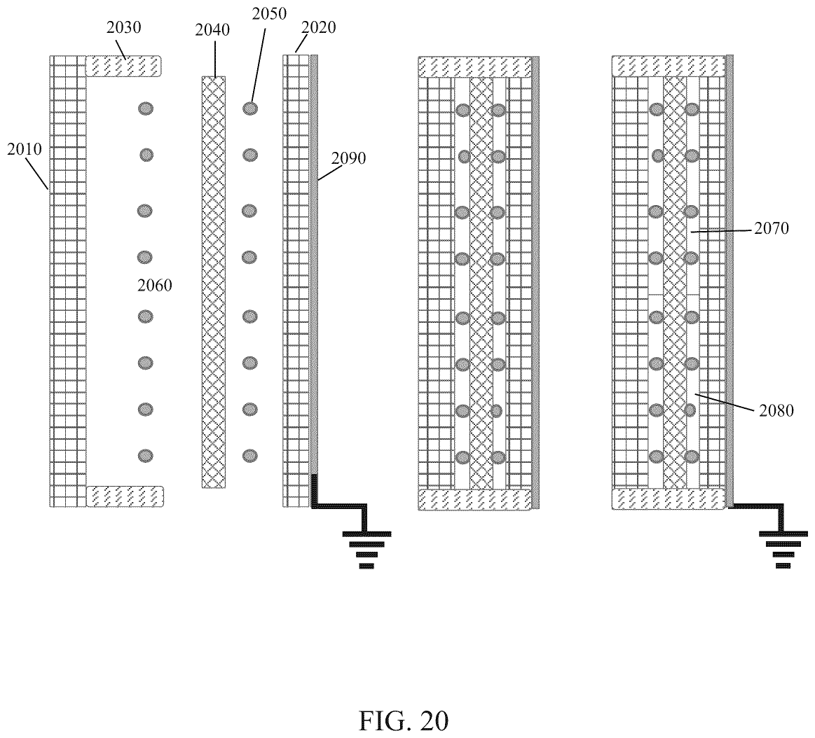

FIG. 20 illustrates the various arrangements/components of the glass (?) layers, in with grounded EMF layer, where 2010 and 2020 represents the optical panes, 2040 represents the wedge shaped conductive layer, 2030 represents the sealant to seals the opposite end of the optical panes and 2050 represents the spacer between the various layers or optical panes. The effects produced are based on the fluid, which is filled in the cavity represented by 2060. The fluid having optical properties. As illustrated by 2070 and 2080, based on the fluid type, upper and lower section may have similar or different optical properties. An additional EMF layer can also be attached to the optical panes or substrates, having grounded connection illustrated as 2090.

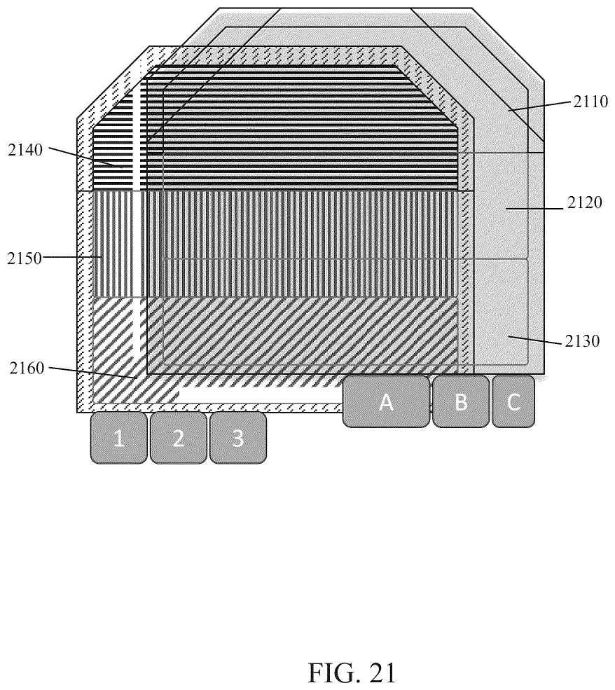

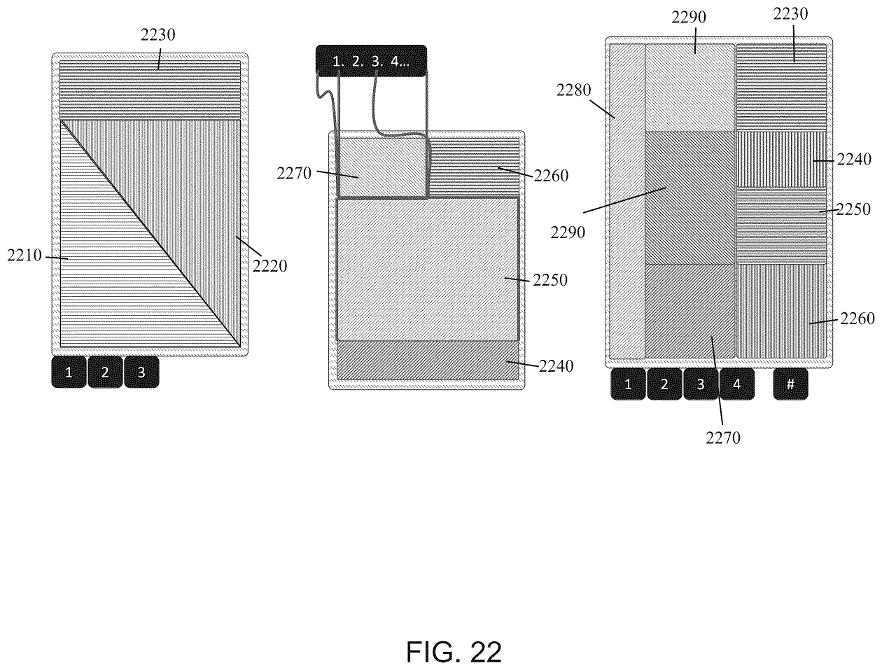

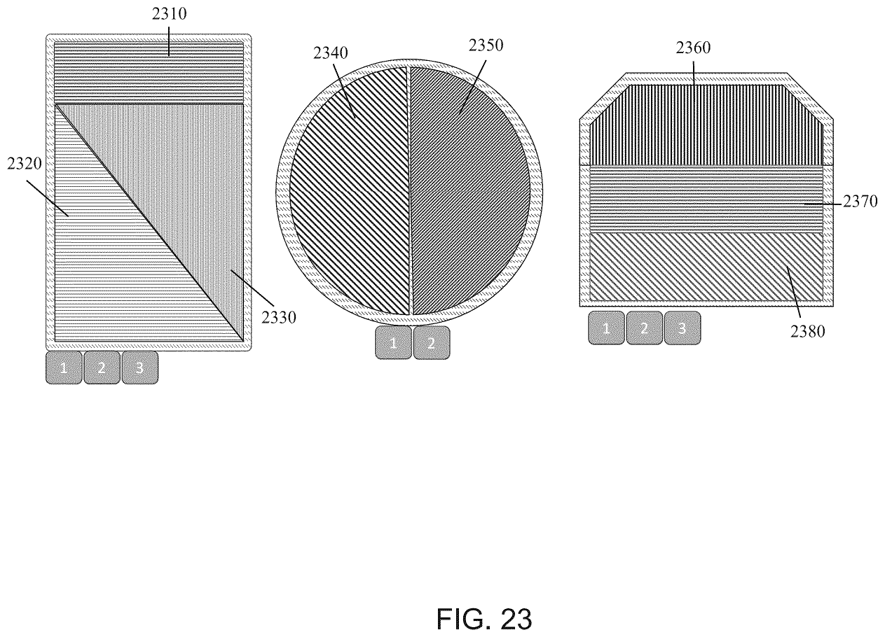

FIG. 21 illustrates 2 pane window with different optics and electronic systems as illustrated by various fluids having different optical characteristics in 2110, 2120, 2130, 2140, 2150 and 2160, being connected to electric systems represented by 1,2,3 and A, B and C.

FIG. 22 illustrates different windows with different optical arrangement and electronic systems as illustrated by various fluids having different optical characteristics in 2210, 2220, 2230, 2240, 2250, 2260, 2270, 2280 and 2290 being connected to electric systems represented by 1,2,3 . . . . N.

It is hereby observed that the different optical fluid produces different optical effects, which are regulated by same number of electrical switch.

Electric Management Systems hereby represent hard or soft switches, electronics hardware, such as Wi-Fi modules, IoT hardware etc. Here Soft switches refer to wireless switches in the mobile application connected to the electronic control module as described earlier. Each electronic system manages at least one fluid.

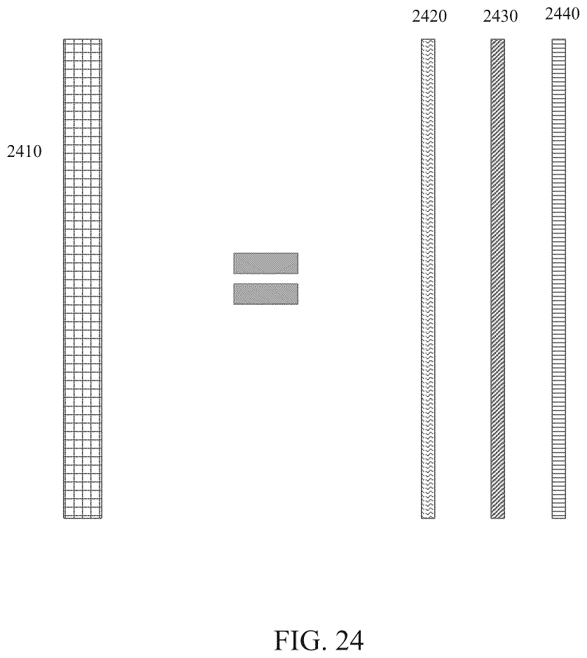

FIG. 24 illustrates different shaped windows with different optical arrangement and electronic systems, as illustrated by various fluids having different optical characteristics in 2410, 2420, 2430, 2440,2450, 2460, 2470 and 2480 being connected to electric systems represented by 1, 2, 3 . . . . N.

The shapes can be regular shaped windows or custom/tailored made.

FIG. 24 illustrates the front view from room side and the window side view of the window 2410 having base pane or substrate 2420 and 2420 having TiO₂ conductive layer 2430 sandwiched between them. The window is packed or sealed with a sealant on the edges and/or corners, with spacers if needed.

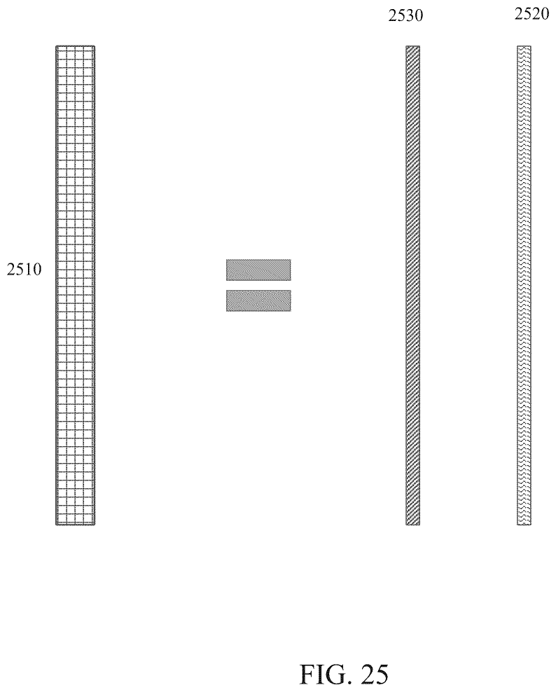

FIG. 25 illustrates the front view from room side and the window 2510 side view of the optical panes having base pane or substrate 2520 having TiO₂ conductive layer 2530. The dynamic window is packed or sealed with a sealant on the edges and/or corners, with spacers if needed.

Various combinations are mentioned below.

TABLE 1

| Substrate 1, 2, | | |
|---|---|---|
| or Multiple | | Horizontal and/or Vertical |
| Options & | Optics 1, 2 or Multiple | Partition 1, 2, or Multiple |
| Combinations | Options & Combination | Options and Combination |
| Clear color or | Transparent Color or | Transparent Color or |
| Non-color | Non-color | Non-color |
| Substrate | | |
| Surface Treated | Opaque, Frosted Color | Opaque, Frosted, or |
| Color or | or Non-color | Non-color |
| Non-color | | |
| Substrate | | |
| Non-Transparent | Semi opaque or | Semi-opaque, semi-frosted, |
| Color or | semi-frosted | or Translucent color or |
| Non-color | | Non-color |
| Substrate | | |
| Substrates | Colored Non-color | Colored Non-color air/gas |
| with additional | air/gas | |
| surface layers | | |
| Substrates | Reflective | Reflective |
| with Reflection | | |
| layers | | |

Additional layers include conductive or non-conductive layers representing electrical conductivity, light control layers or surface energy treatments (such as, ITO, FTO, TiO₂, hydrophobic, hydrophilic, functional coatings and layers). Other optical, and non-optical materials could include materials used for dye-sensitized solar cell (DSSC) materials but not limited to oxidized dyes or electrolytes.

Window pane or substrate could represent pane, laminated pane, heat strengthened pane, PET, PEN, film, polycarbonate, acrylic, polyethylene, fiberpane, fiberglass, soda lime glass, borosilicate glass, etc.

The optical management system or electronics management systems consists of electronics, wiring, power and all necessary external hardware to successfully operate the kinetic glass. There are a numerous options for the optics materials to produce a numerous effects such as light control, privacy control, aesthetics control, heat control, power generation, and other similar options one could desire. The entire hardware excluding the kinetic glass could be stationed immediate or remotely stashed away in a semi or completely private closet-like area.

Some of the window pane shapes selected from or by combination of shapes like Circle, Square, Rectangle, Triangle, Oval, Diamond, Pentagon, Hexagon, Heptagon, Octagon, Nonagon, Decagon, Parallelogram, Rhombus, Ellipse, Star, Crescent, Cross, Plus Sign, wordings, Arrow and any MTO (Made to order) shapes.

Various combinations of polar and non-polar materials, which are adapted as optics 1, optics 2, optics 3 and so on.

The polar materials that are suitable for this invention include families of materials such as Water, Water-based materials, Ethanol, Acetic acid, Propylene glycol, Polyvinylpyridine (PVPy), Polyvinylpyrrolidone (PVP), Polyvinyl alcohol (PVA), Polyvinyl acetate (PVAc), Polyethylene oxide (PEO), Sucrose, Urea, Glycols, Polyglycols, Silicone oils, Ester oils, Polyphenyl ether oils, Polyvinylpyrrolidone (PVP), Polyvinyl alcohol (PVA), Polyvinyl acetate (PVAc), and Polyethylene oxide (PEO).

On the other hand, non-polar materials suitable for this invention include families such as Mineral oils, Synthetic hydrocarbons, Perfluoroalkyl ether, Silicone oils, Methyl hydrogen silicone oil (can be either polar or non-polar based on the chemistry for example phenyl or methyl), Petroleum oils, Fluorine-based oils, Chlorine-based oils, Perfluorinated polyether (PFPE) oils, Polymers of chlorotrifluoroethylene (CTFE) or its derivatives, Fluorolube oils, Chlorofluoro-oils, Carbon tetrachloride, Hexane, Cyclohexane, Benzene, Toluene, Xylene, Naphthalene, Paraffin wax, Petrolatum, Mineral spirits, Isopropyl alcohol, and Butane, and dependent family of materials etc. These polar and non-polar materials are often may be characterized by some of the following preferable properties such as: a) viscosities suitable for movement in the said cavities functional at least in the −40° C. to 100° C. range, b) Very low vapor pressure, c) Highly, UV, heat, NIR & humidity stable, d) High clarity or opacity or dark or non-dark, e) highly durable, and f) High viscosity index along with other preferable properties such as low or no toxicity and industrial quality.

Some options for red, blue, and green pigments that can be used in weak or strong non-polar fluids or solvents. Wherein Red Pigments can be selected from Diketopyrrolo-pyrrole, Pyrrole and Isoindolinone derivatives, Diarylide and Azo derivatives, Perylene and Dinitroaniline derivatives, Carbazole and Diphenylmethane derivatives, Thioindigo and Indanthrone derivatives, Perylene and Quinacridone derivatives, Quinacridone and Perinone derivatives, Iron Oxide, and Chrome derivatives. Wherein the Blue Pigments is selected from Anthraquinone and Indigoid derivatives, Anthraquinone and Isoindoline derivatives, Triarylmethane derivatives, Anthraquinone and Indanthrone derivatives, Copper Phthalocyanine and Isoindoline derivatives, Isoindoline and Indigoid derivatives, Phthalocyanine and Indanthrone derivatives, Cobalt and Ultramarine derivatives. Wherein Green Pigments can be selected from Monomethine and Diamine derivatives, Isoindoline and Indoline derivatives, Isoindolinone and Indigoid derivatives, Phthalocyanine and Isoindoline derivatives, Monomethine and Diamine derivatives, Isoindolinone and Indigoid derivatives, Phthalocyanine and Chromium Oxide derivatives, Copper Phthalocyanine and Chromium Oxide derivatives.

The window in its natural or default state provides privacy because the treated surface(s) scatters light on impact. Because of proper wetting characteristics (microscopic-touch) between the treated surfaces and the choice of fluid 15 or 19, the window looks transparent.

Various operating modes of the dynamic window:
Privacy Functionality: The dynamic window can be adjusted to provide privacy when needed by changing its transparency.
Fixed-color Selection: The dynamic window allows the user to select a fixed color, providing a unique aesthetic design feature.
Kinetic Materials: The dynamic window uses kinetic materials that can change properties such as density and optical properties, providing versatile control over light and heat.
Segmentations: The dynamic window can be segmented into stationary or movable sections to provide additional control over light and heat.
Wedge/Gradient Design: The dynamic window can be designed with a wedge or gradient shape to provide additional control over light and heat.
Surface Treatments: The dynamic window can be treated with various surface treatments to enhance its functionality, such as controlling its light and heat properties.
Multi-layer Façade: The invention is equipped with multiple layers of façade that can be adjusted to control light and heat entering a building.

As will be appreciated, several features of the illustrative embodiments provide user control over how much light passes through the window as well as control over the area of the window letting light pass through. The fluid introduction elements control when a user wants to switch from an opaque setting (that provides privacy as a default state) to a transparent state so that the other side of the window becomes visible. The height control allows the user to determine how much of the viewable area can be seen, replicating the function of blinds. The second fluid provides the user with fine tune control over how much light passes through so that for example, if the day is very bright, the outside can be seen at whatever comfortable level of light passing through is desired by the user.

The application also finds its application in the field of avionics, marine, transportation, and similar sectors where optical panes are used in windows, doors, mirrors, glass art, glass walls, skylights, glass partitions, automotive glass, glass roofs, glass floors, or façades.

Depending on the particular embodiment, the computing device may be embodied as a server, desktop computer, laptop computer, tablet computer, notebook, netbook, Ultrabook™, mobile computing device, cellular phone, smartphone, wearable computing device, personal digital assistant, Internet of Things (IoT) device, reader device, access control device, control panel, processing system, router, gateway, and/or any other computing, processing, and/or communication device capable of performing the functions described herein.

The computing device includes a processing device that executes algorithms and/or processes data in accordance with operating logic, an input/output device that enables communication between the computing device and one or more external devices, and memory which stores, for example, data received from the external device via the input/output device.

The input/output device allows the computing device to communicate with the external device. For example, the input/output device may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device. The input/output device may include hardware, software, and/or firmware suitable for performing the techniques described herein.

The external device may be any type of device that allows data to be inputted or outputted from the computing device. For example, in various embodiments, the external device may be embodied as the IoT module, the controller, the wireless transceiver, the light ring, the audio device, the movement sensor, the environmental sensor, the additional feedback device, and/or the external device (e.g., the access control system, the smart home system, the cloud server, the mobile device, and/or the external IoT module). Further, in some embodiments, the external device may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device may be integrated into the computing device.

The processing device may be embodied as any type of processor(s) capable of performing the functions described herein. In particular, the processing device may be embodied as one or more single or multi-core processors, microcontrollers, or other processor or processing/controlling circuits. For example, in some embodiments, the processing device 302 may include or be embodied as an arithmetic logic unit (ALU), central processing unit (CPU), digital signal processor (DSP), and/or another suitable processor(s). The processing device may be a programmable type, a dedicated hardwired state machine, or a combination thereof. Processing devices with multiple processing units may utilize distributed, pipelined, and/or parallel processing in various embodiments. Further, the processing device may be dedicated to performance of just the operations described herein, or may be utilized in one or more additional applications. In the illustrative embodiment, the processing device is of a programmable variety that executes algorithms and/or processes data in accordance with operating logic as defined by programming instructions (such as software or firmware) stored in memory. Additionally or alternatively, the operating logic for processing device may be at least partially defined by hardwired logic or other hardware. Further, the processing device may include one or more components of any type suitable to process the signals received from input/output device or from other components or devices and to provide desired output signals. Such components may include digital circuitry, analog circuitry, or a combination thereof.

The memory may be of one or more types of non-transitory computer-readable media, such as a solid-state memory, electromagnetic memory, optical memory, or a combination thereof. Furthermore, the memory may be volatile and/or non-volatile and, in some embodiments, some or all of the memory may be of a portable variety, such as a disk, tape, memory stick, cartridge, and/or other suitable portable memory. In operation, the memory may store various data and software used during operation of the computing device such as operating systems, applications, programs, libraries, and drivers. It should be appreciated that the memory may store data that is manipulated by the operating logic of processing device, such as, for example, data representative of signals received from and/or sent to the input/output device in addition to or in lieu of storing programming instructions defining operating logic. As illustrated, the memory may be included with the processing device and/or coupled to the processing device depending on the particular embodiment. For example, in some embodiments, the processing device, the memory, and/or other components of the computing device may form a portion of a system-on-a-chip (SoC) and be incorporated on a single integrated circuit chip.

In some embodiments, various components of the computing device (e.g., the processing device and the memory) may be communicatively coupled via an input/output subsystem, which may be embodied as circuitry and/or components to facilitate input/output operations with the processing device, the memory, and other components of the computing device. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device may include other or additional components, such as those commonly found in a typical computing device (e.g., various input/output devices and/or other components), in other embodiments. It should be further appreciated that one or more of the components of the computing device described herein may be distributed across multiple computing devices. In other words, the techniques described herein may be employed by a computing system that includes one or more computing devices. Additionally, although only a single processing device, I/O device, and memory, it should be appreciated that a particular computing device may include multiple processing devices, I/O devices, and/or memories in other embodiments. Further, in some embodiments, more than one external device may be in communication with the computing device.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

Persons of ordinary skill in the art may appreciate that numerous design configurations may be possible to enjoy the functional benefits of the inventive systems. For example, while the operating system is shown on the bottom extremity of the window system frame and the dispensing ports are shown dispensing fluid from the bottom, it should be understood that the fluids may be dispensed from different locations around the cavity 22. In some embodiments, the surface treatment may be modified, and yet other elements of the system may also be modified to provide the same effects, for example, in some embodiments, the panes 24 and 26 may be selected as transparent by nature (which unlike the above embodiment provides no privacy in a default state). The selection of the fluid types may then be opaque instead of clear. In which case, the window needs to be filled with the opaque fluid to provide a privacy setting to the user. The principle is reversed in this example but there are several advantages in the current embodiment, too. In another embodiment, the selection of fluid may provide an open a broad range of applications to the entire window and door industry. With a highly efficient fluid management system, the system could use various fluids based on day, night, season, weather, and the interests of the consumer.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Thus, given the wide variety of configurations and arrangements of embodiments of the present invention the scope of the invention is reflected by the breadth of the claims below rather than narrowed by the embodiments described above.

The invention claimed is:

1. A dynamic window, comprising:
a first pane;
a second pane, wherein the first pane and the second pane are arranged to define a cavity between the first pane and the second pane;
a third pane, wherein the second pane and third pane are arranged to define a cavity between the second pane and third pane. a treated surface on at least one of the first pane or the second pane or the third pane;
a fluid container placed remotely or immediately coupled to one of the cavities of the panes for holding a material such as a fluid or a gas or a gel, wherein the material can be configured to be selected from a variety of air or fluids or gels characterized by various optical and physical properties;
one or more ports positioned between the material container and one or more of the cavities; and
a controller coupled to the material container, wherein the controller is configured to controllably manage one or more materials into one or more cavities through the port or ports to control a state of transmissivity, absorptivity, reflectivity, opacity, or other optical properties of light and power generation through the panes.

2. The dynamic window of claim 1, wherein the treated surface is a roughened surface, a modified surface, a hydrophobic surface, a hydrophilic surface, a oleophobic surface, or omniphobic surface or a combination thereof.

3. The dynamic window of claim 1, wherein the treated surface is on an inner surface of one or more panes facing inward toward the cavity, wherein the material or fluid comes fully or partially in contact with the treated surface.

4. The dynamic window of claim 1, wherein the treated surface is configured to provide a default opaque or clear or some other optical state in the absence or presence of one or more materials in the cavity.

5. The dynamic window of claim 1, wherein the fluid includes a clear fluid, and a presence of the clear fluid in the cavity generate a transparent condition through the panes.

6. The dynamic window of claim 1, wherein the fluid includes a colored fluid, and a presence of the colored fluid in the cavity change the state of transmissivity from an opaque state to a translucent or to other optical states based on the fluid and selection of surface treatments.

7. The dynamic window of claim 1, wherein the fluid container comprises:
a first container and a first clear or opaque or colored fluid in the first container, a second container and a second different colored or clear or opaque fluid in the second container, different from first fluid, wherein:
a dispense of the clear fluid into the cavity transforms the state of transmissivity from a default opaque state to a transparent state, and a dispense of the colored fluid into the cavity changes the state of transmissivity from the transparent state to a translucent state, wherein at least fluid can be managed inside the cavity to realize at least one optical effect of the fluid in the cavity.

8. The dynamic window of claim 1, wherein the fluid may include at least one fluid such as clear, transparent, opaque, dark, translucent, absorbing, reflective, or similar fluid, and a presence of at least one of such fluids creates optical effects not limited to light control effects such as transparent, clear, reflective, absorbing, privacy, dark, opaque, or translucent effects or similar effects. In the absence of one or more fluids in the cavity, the dynamic window generates the desired optical state depending on the pane color and surface treatment, selection, and often creates a clear optical view of the environment on the other side.

9. A dynamic window system comprising:
a double-paned window, including an air-gap between panes;
an abraded surface on the double-paned window, wherein the abraded surface is configured to scatter light passing through the air-gap and generating a default opaque state of the window;
a fluid container coupled to the double-paned window and having access to the airgap;
a controller coupled to the fluid container, wherein the controller is configured to vary the quantity of fluid in the cavity and change the amount of fluid in the cavity between the two panes of the window to adjust the amount of light transmitted, reflected, back-ward scattered, forward-scattered or absorbed, through the window; and
a light sensor coupled to the controller and configured to measure an amount of light transmitted through the window and provide feedback to the controller for automatically or manually adjusting the quantity of at least one fluid in the cavity of the dynamic window pane.

10. The system of claim 9, wherein the above described smart window is used in specialty rooms such as an medical operation theatre or other rooms, where absence of minimal magnetic or electric inference is a requirement by adding a grounded or earthed transparent conductive layer on any of the surface layers of the window.

11. The dynamic window system of claim 9, wherein the fluid container comprises a bladder and the quantity of at least one fluid in the cavity is adjusted by changing a pressure within the bladder.

12. A system for operating a dynamic window, comprising:
one or more panes, wherein the one or more panes are surface treated, having a modified, roughened, hydrophilic, oleophobic, omniphobic or hydrophobic surface;
a fluid container coupled to the one or more panes, wherein the fluid container contains one or more fluids capable of gradually changing and controlling the optical properties of the one or more panes;
one or more ports positioned between the fluid container and the one or more panes; and
a controller coupled to the fluid container, wherein the controller is configured to manage the one or more fluids by selectively introducing them through the port or ports to control the optical properties of one or more panes effecting the light characteristic of the interior environment and external view of the dynamic window.

13. A kinetic glass comprising a plurality of layers, wherein at least one fluid layer is capable of movement in response to an external force, wherein the movement of said layer is controlled by an actuator, and wherein said kinetic glass is capable of transitioning among at least a first optical state and a second optical state in response to a control signal such that, for example, top portion of the window can be completely dark and opaque from fluid 1 whereas the remaining bottom portion of the window can be transparent from fluid 2 to view the other side of the dynamic window. Fluids 1 and 2 are often non-miscible and have specific optical and physical properties.

14. The system of claim 12, wherein the one or more panes comprise a double-paned or triple-paned window with at least one of the panes being a dynamic glass or kinetic glass.

15. The system of claim 12, wherein the one or more fluids comprise at least one fluid selected from the group consisting of clear, transparent, opaque, dark, reflective, absorbing, and translucent fluids, and the presence of at least one of these fluids in the cavity between the panes creates optical or light control effects including, but not limited to, such as transparency, diffuse reflectivity, mirror like reflectivity, absorption, darkness, opacity, translucency, or similar optical effects.

16. The system of claim 12, wherein the surface treatment on the one or more panes is configured to provide a default optical state in the absence or presence of the one or more fluids in the cavity, such as an opaque or clear state.

17. The system of claim 12, wherein the one or more ports are positioned such that the one or more fluids can be selectively introduced into different cavities between the panes to achieve different optical effects on different locations or portions of the window.

18. The system of claim 12, further comprising a fluid-based smart dye-sensitized solar cell, wherein the dynamic smart window is configured to be used as a substrate for the dye-sensitized solar cell insulating glass or IG.

19. The system of claim 12, further comprising a user interface for allowing a user to manually control the properties of the dynamic smart window, including but not limited to transparency, color, and reflectivity.

20. The system of claim 12, further comprising a machine learning algorithm for predicting and adjusting the properties of the dynamic smart window based on past usage and environmental conditions, thereby improving energy efficiency and occupant comfort over time.

21. A system for intelligent heat and light control in a building comprising:
a control unit;
one or more sensors for monitoring building orientation with respect to environmental elements such as the sun, wind, and geographical location of the dynamic pane location and its elevation;
a fluid management system for regulating heat exchange based on the data from the sensors; and
a fluid management system for circulating one or more fluids or gels through the building's façade based on the computer readable instructions selected by the control unit, wherein the computer readable instructions are stored in the memory of the control device.

22. The system of claim 21, wherein the system is capable of adapting to changing environmental conditions and optimizing energy efficiency or occupant comfort depending on the user's preferences, the automated intelligent system, building management system, or third-party software and hardware integration.

23. A system for intelligent heat and light control in a building comprising:
a control unit;
sensors for monitoring building orientation and correlating the health of occupants with respect to environmental elements such as the orientation of sun, wind, humidity, humidity ratio, air-quality, desirable and undesirable radiation, geographical location of the dynamic pane location and its elevation;
air quality index, indoor particulate size, noise level, wind speed and direction, barometric pressure, dew point, altitude, carbon dioxide concentration, and light pollution a fluid management system for adjusting optimal visual comfort and energy management based on the data from the sensors;
a fluid management system including IR reflecting for transferring fluid, or a gel through the building's façade based on the intelligent programs selected by the control unit; and
at least one energy storage unit to store energy from a fluid-based smart dye-sensitized solar cell.

24. The system of claim 23, wherein the system is capable of adapting to changing environmental conditions and optimizing energy efficiency and occupant comfort at the same time, depending on the user's preferences.

25. The fluid-based smart dye-sensitized solar cell of claim 24 comprising:
a photoelectrode layer coated with a dye-sensitized fluid electrolyte comprising at least one redox couple;
a counter electrode layer configured to allow passage of electrons to the photoelectrode layer; and
a transparent conductive substrate layer positioned between the photoelectrode layer and the counter electrode layer.

26. The solar cell of claim 25, wherein the dye-sensitized fluid electrolyte comprises a mixture of a sensitizer dye and a redox mediator.

27. The solar cell of claim 25, wherein the photoelectrode layer comprises a semiconductor material selected from the group consisting of titanium dioxide, zinc oxide, and tin oxide or similar layer.

28. The solar cell of claim 25, wherein the counter electrode layer comprises a metal or conductive polymer selected from the group consisting of platinum, gold, palladium, and poly aniline.

29. The solar cell of claim 25, further comprising at least one energy storage unit to store energy from the fluid-based smart dye-sensitized solar cell, wherein the fluid management system can be adjusted to optimize visual comfort and energy generation at the same time.

30. The solar cell of claim 25, wherein the dye-sensitized fluid electrolyte comprises a mixture of a sensitizer dye and a redox mediator.

31. A system of claims 1, 12 and 25, wherein the dynamic window is capable of integrating with the Internet of Things (IoT) and other smart home or building management systems, allowing for seamless control and automation of the dynamic window's properties based on user preferences, environmental conditions, and other factors.

32. A system of claim 12, wherein the manufacturing of kinetic glass using existing IG manufacturing processes, in order to reduce the environmental impact of the production process and to create true sustainability for the circular economy for the future dynamic window products for the residential and commercial and other industries.

33. A kinetic glass comprising at least one pane, wherein the pane comprises a transparent photovoltaic layer configured to generate power, thereby enabling the kinetic glass to be utilized for light control, privacy control, heat control, and power generation application.
